(19) United States
(12) Patent Application Publication
(10) Pub. No.: US 2010/0025252 A1
(43) Pub. Date: Feb. 4, 2010

(54) Ceramics coating metal material and manufacturing method of the same

(76) Inventor: Shinsuke Mochizuki, Shizuoka (JP)

Correspondence Address: HARNESS, DICKEY & PIERCE, P.L.C., P.O. BOX 8910, RESTON, VA, 20195, US

(21) Appl. No.: 12/311,331

(22) PCT Filed: Sep. 27, 2006
(86) PCT No.: PCT/JP2006/319187

§ 371 Date: Jul. 27, 2009

(51) Int. Cl. B32B 15/04; C25D 5/18; C25D 11/02

(52) U.S. Cl. 205/50; 205/107

(57) ABSTRACT

[Problem] To enable film formation of an extremely-smooth and high-strength plasma electrolytic oxide film (ceramics film) not only on an Al-based metal, but also on a substrate of an Mg-based metal and a Ti-based metal.

[Means for Solution] A power distribution pattern disposing an alternating pulse mode in which, before or after one or more positively-polarized anode-type pulse mode or one or more negatively-polarized cathode-type pulse mode, one above described anode-type pulse mode and one above described cathode-type pulse mode alternately appear is used as a pulse mode. A deformed sine waveform in which a peak position of the current waveform of the pulse mode is shifted from the pulse center position is used.

### TECHNICAL FIELD

The present invention relates to a ceramics coating metal material forming a crystalline plasma electrolytic oxide film on a surface part of a metal substrate comprising an Al-based metal, an Mg-based metal, or a Ti-based metal and to a manufacturing method thereof.

### BACKGROUND ART

Recently, as a surface processing technique with respect to a substrate of an Al member or the like, a plasma electrolytic oxidation method of distributing a current of an arbitrary pulse mode between the substrate and a cathode electrode, generating a plasma discharge on a contact interface of the substrate and an electrolytic solution, and subjecting a surface part of the substrate to a conversion process into a plasma electrolytic oxide film draws attention.

According to such a plasma electrolytic oxidation method, a plasma electrolytic oxide film (ceramics film) excellent in corrosion resistance, wear resistance, etc. can be formed, for example, on the substrate of the Al member or the like. However, in the conventionally known method, a complex processing apparatus and operations are necessary; moreover, due to instability of the electrolytic solution, the quality of the formed plasma electrolytic oxide film (ceramics film) is also inclined to be instable, and the film thickness is not uniform in some cases.

Furthermore, the conventional method is limited to the Al-based metal, and the plasma electrolytic oxide film (ceramics film) cannot be formed on a metal substrate of an Mg-based metal or a Ti-based metal.

Recently, a plasma electrolytic oxidation method draws attention as a surface processing technique with respect to a metal substrate such as an Al member. According to the plasma electrolytic oxidation method, a surface part of the metal substrate such as an Al member can be converted into ceramics comprising, for example, Al2O3; therefore, characteristics such as corrosion resistance and wear resistance can be imparted to the metal substrate of, for example, the Al member. In relation to application of such plasma electrolytic oxidation to the metal substrate such as the Al member, for example, a method of forming an Al2O3-based ceramics film comprising 60 vol. % of corundum, 30 vol. % of aluminosilicate, and 8 vol. % of alumina and having a thickness of 65 μm on the surface of duralumin (2014 alloy) is known (see below mentioned Patent Document 1).

In this method, aqueous solution containing potassium hydroxide and tetrasodium silicate is used as an electrolytic solution, duralumin serving as an anode electrode and stainless steel serving as a cathode electrode are immersed therein, and an alternating voltage is distributed by applying a high voltage of at least 700 V between the electrodes. At that point, a current waveform, in which, after rising the current from zero to a maximum value within ¼ time of one cycle, the current value is lowered to 40% or less of the maximum value, is employed as the anode current which is a half-wave current.

When such power distribution is carried out, micro arcs are generated on the surface of the duralumin, electrolytic oxidation progresses on the surface of duralumin, and an Al2O3-based ceramics film is formed. However, in such conventional method, in formation of the ceramics film, film formation operations are completed by carrying out the electrolytic oxidation process three times in total by using different apparatuses; therefore, the processing apparatuses have a complex system, and operations are inevitably complicated. Moreover, since the electrolytic solution is also instable, there is a problem that the quality of the formed ceramics film lacks stability.

On the other hand, a below plasma electrolytic oxidation process method has been also conventionally known (see below Patent Document 2). In this method, an electrolytic solution containing alkali metal hydroxide, alkali metal silicate, alkali metal pyrophosphate, and a peroxide compound is used, and an Al alloy article is disposed therein as an anode electrode. Then, a current pulse mode in which an anode pulse mode and a cathode pulse mode are alternated is distributed between the anode electrode and a cathode electrode. The power distribution mode at this point is as described below.

First, in an initial stage that is 5 to 90 seconds from initiation of power distribution, the power is distributed at a current density of 160 to 180 A/dcm2, and then the current density is lowered to 3 to 30 A/dm2. Then, without changing the state, the power distribution is continued until the film thickness reaches a desired thickness without adding any interference operation and changing the mode in which the used electric power is autonomically reduced. Therefore, the case of this method has a characteristic that an extremely large current flows between the anode electrode and the cathode electrode so as to satisfy the above described high current density in the initial stage of power distribution. This is for increasing the film formation speed of the plasma electrolytic oxide film to be formed.

However, since the large current is distributed in the initial stage of power distribution in the case of this method, strong minute arc discharges are generated, and the apparent film formation speed of the plasma electrolytic oxide film is increased. However, at the same time there are problems that, since the minute arc discharges do not occur in uniform distributed over the surface of the anode electrode (Al alloy article), burning occurs at the surface location where the minute arc discharges are concentrated, that the film thickness, etc. of the formed plasma electrolytic oxide film become non-uniform, and that the surface thereof tends to be an irregular surface.

In addition to such problems, as a recent trend, in the material field of, for example, pistons and cylinder liners of internal combustion engines, parts of pumps and compressors, and parts of hydraulic devices and air compression devices, manufacturing them by the materials such as light-weight Al-based metals, Mg-based metals, and Ti-based metals has been studied from the viewpoint of energy saving. In that case, required performances include not to be worn even under an environment of a high-temperature corrosive atmosphere, in other words, being excellent in various characteristics such as corrosion resistance, heat resistance, and heat insulation, and having high hardness, a smooth surface, a small friction coefficient with respect to an opposed material, and excellent slidability.

From these viewpoints, the Al-based metals, the Mg-based metals, or the Ti-based metals having the surface part converted into ceramics by plasma electrolytic oxidation are conceived to have sufficient characteristics. However, in the conventional manufacturing methods of the ceramics coating metal materials, the substrate is limited to the Al-based metal, and forming a plasma electrolytic oxide film (ceramics film) on another metal substrate such as an Mg-based metal or a Ti-based metal is not supposed at all. Moreover, sufficient characteristics, particularly, further characteristic improvement about the smoothness of the surface of the plasma electrolytic oxide film are desired.

Patent Document 1: U.S. Pat. No. 5,616,229

Patent Document 2: Japanese Kohyo Patent Publication No. 2002-508454

### DISCLOSURE OF THE INVENTION

### Problems to be Solved by the Invention

The present invention has been created in view of above described conventional various circumstances, and it is an object to provide a manufacturing method of a ceramics coating metal material which is excellent in various characteristics such as corrosion resistance, heat resistance, and heat insulation, has high hardness, is smooth, has a small friction coefficient, and is excellent in slidability.

### Means for Solving the Problems

In order to achieve the above described object, a manufacturing method of a ceramics coating metal material according to the present invention includes storing a neutral or weak alkaline electrolytic solution of at least stirred and mixed alkali metal hydroxide, alkali metal silicate, and alkali metal polyphosphate in an electrolytic bath; immersing a metal substrate comprising an Al-based metal, an Mg-based metal, or a Ti-based metal as an anode electrode in the electrolytic solution and constituting the electrolytic bath, which is storing the electrolytic solution, as a cathode electrode; distributing a current of an arbitrary pulse mode between the metal substrate and the cathode electrode so as to generate a plasma discharge on a contact interface between the metal substrate and the electrolytic solution and subject a surface part of the metal substrate to a conversion process into a plasma electrolytic oxide film; using merely a power distribution pattern disposing an alternating pulse mode, in which one positively-polarized anode-type pulse mode and one negatively-polarized cathode-type pulse mode alternately appear, as the arbitrary pulse mode; setting the total of on time of the anode-type pulse mode to be longer than the total of on time of the cathode-type pulse mode so that the amount of electric power of the anode-type pulse mode is larger than the amount of electric power of the cathode-type pulse mode; and using a deformed sine waveform P2 or P1 as a current waveform of the pulse mode, the deformed sine waveform being time-delayed or time-advanced and having a peak position of the current waveform shifted from a pulse center position in a time axis direction in accordance with surface roughness or hardness of the plasma electrolytic oxide film; wherein the deformed sine waveform P2 in the time-delayed direction is used when the plasma electrolytic oxide film is to have surface roughness of good surface coarseness than having high hardness; and the deformed sine waveform P1 in the time-advanced direction is used when the plasma electrolytic oxide film is to have high hardness than having surface roughness of good surface coarseness.

According to the manufacturing method of the ceramics coating metal material according to the present invention having such configuration, first, since the neutral or weak alkaline electrolytic solution is used, stability and safety is improved compared with the conventional neutral electrolytic solution.

Moreover, in the present invention, the cathode electrode, which has been conventionally immersed in an electrolytic solution, is constituted by the electrolytic bath; therefore, a uniform electric field is formed, and the uniformity and quality stability of the plasma electrolytic oxide film (ceramics film) is improved.

Furthermore, in the present invention, power distribution is carried out by the AC mode in which the anode-type pulse mode (A mode) and the cathode-type pulse mode (C mode) alternately appear as the applied pulse mode. Therefore, the actions of the above described A mode and the C mode alternately continue acting on the surface of the formed plasma electrolytic oxide film. As a result, a dense, uniform, and smooth plasma electrolytic oxide film can be reliably and stably formed.

In the AC mode, the on time of the anode pulses and the on time of the cathode pulses is arbitrarily set. However, in order to reliably form the plasma electrolytic oxide film, the amount of the electric power of the anode pulse, which is an integral value of the half-wavelength, is desired to be larger than that of the cathode pulses by setting the total of the on time of the anode pulses to be longer than the total of the on time of the cathode pulses.

Furthermore, in the present invention, the electrolytic solution is cooled from the bottom side by disposing the cooling device at the bottom of the electrolytic bath, a uniform temperature distribution is realized, and the uniformity of the plasma electrolytic oxide film (ceramics film) is improved.

In addition, in the present invention, the deformed sine waveform in which the peak position is shifted in the time axis direction in accordance with the surface roughness or hardness of the plasma electrolytic oxide film is used as the pulse current waveform of the applied pulse mode; as a result, characteristics upon pulse rise or pulse decay are enhanced, and strong plasma reactions are obtained.

In addition, in the present invention, a metal substrate which has undergone the neutral degreasing step and the water-washing step is used as the metal substrate; as a result, the plasma electrolytic oxide film (ceramics film) is reliably uniformized.

### EFFECTS OF THE INVENTION

The present invention employs the above described configurations; as a result, an extremely-smooth high-strength plasma electrolytic oxide film (ceramics film) can be obtained, and a plasma electrolytic oxide film (ceramics film) can be formed well not only on the Al-based metal, but also on the substrate of the Mg-based metal or Ti-based metal.

### BRIEF DESCRIPTION OF THE DRAWINGS

FIG. 1 is a schematic configuration diagram showing an example of an apparatus for carrying out the present invention;

FIG. 2 is a diagram showing an example of the waveforms of anode pulses (A mode) of the current used in the present invention;

FIG. 3 is a diagram showing an example of waveforms of cathode pulses (C mode) of the current used in the present invention;

FIG. 4 is a diagram showing an example of the waveforms of alternating pulses (AC mode) of the current used in the present invention;

FIG. 5 is a diagram showing an example of a waveform pattern of a pulse mode of the current used for an Al-based metal in the present invention;

FIG. 6 is a diagram showing an example of a waveform pattern of a pulse mode of the current used for a Mg-based metal or a Ti-based metal in the present invention; and

FIG. 7 is a diagram showing deformed usage examples of the waveforms of the pulses used in the present invention.

### BEST MODE FOR CARRYING OUT THE INVENTION

Before explaining an embodiment of the present invention in detail below based on drawings, a configuration of an apparatus for carrying out a manufacturing method of a ceramics coating metal material according to the present invention will be explained.

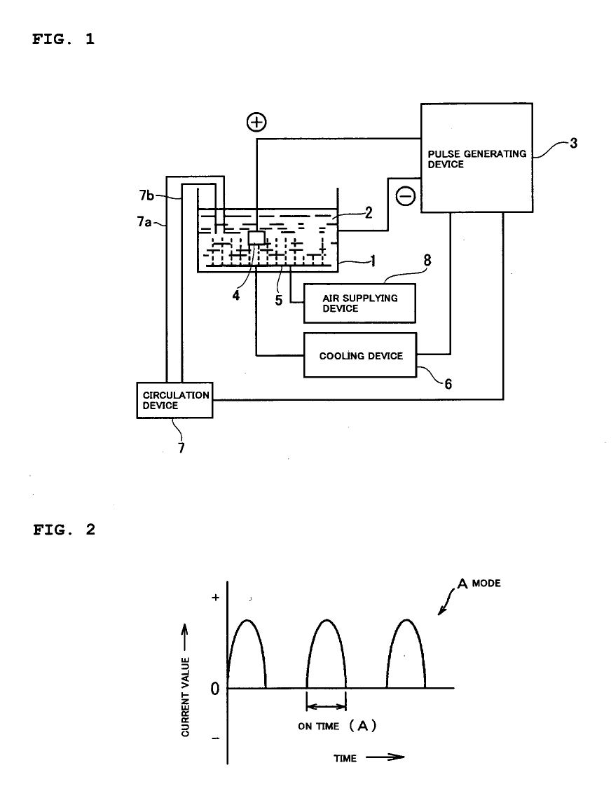

As shown in FIG. 1, an electrolytic solution 2 of at least stirred and mixed alkali metal hydroxide, alkali metal silicate, and alkali metal polyphosphate is stored in an electrolytic bath 1, which is formed like a bathtub. Examples of the alkali metal hydroxide used in the electrolytic solution 2 include KOH, which is particularly suitably used, and, other than that, NaOH. Water glass (Na2SiO2) is suitably used as the alkali metal silicate. Meanwhile, for example, one or two species of Na4P2O7, Na2PO4, Na6P6O18, etc. can be used as the alkali metal polyphosphate.

Such electrolytic solution 2 is prepared by distilling the above described components or dissolving the components in deionized water. In that case, the concentrations of the components are arbitrarily adjusted in relation to the film thickness, hardness, etc. of a plasma electrolytic oxide film (ceramics film) formed on a metal substrate. When KOH is used as the alkali metal hydroxide, normally, the concentration thereof is 1 to 3 g/L. When water glass is used as the alkali metal silicate, the concentration thereof is set to 2 to 5 g/L; and, when Na2P2O7 is used as the alkali metal polyphosphate, the concentration thereof is set to 2 to 6 g/L.

The concentrations are set so that the electrolytic solution 2 in the present embodiment is neutral when the metal substrate, which will be described later, is an aluminium-based substrate and is weak alkaline when it is a Mg or Ti-based substrate. The pH value of the electrolytic solution 2 is set so as to achieve both good generation of plasma filaments, which will be described later, and safety of an operator, and organic substances are eliminated as much as possible in order to maintain good peeling resistance of a plasma electrolytic oxide film, which is finally formed.

On the other hand, the electrolytic bath 1 storing the electrolytic solution 2 has a structure forming a cathode electrode comprising a material exhibiting good conductivity such as stainless steel, and a pulse generating device 3 which enables supply of the currents of the pulse modes, which will be described later, is electrically connected to the electrolytic bath 1, which is formed as the cathode electrode.

The metal substrate 4 comprising an Al-based metal, an Mg-based metal, or a Ti-based metal is immersed as an anode electrode in the electrolytic solution 2 stored in the electrolytic bath 1. A metal substrate which has undergone a neutral degreasing step and a water-washing step in advance in order to improve film formation performance is used as the metal substrate 4 comprising the Al-based metal, the Mg-based metal, or the Ti-based metal, and the substrate is subjected to a drying step after a conversion process. The pulse generating device 3 is also electrically connected to the metal substrate 4, which is constituting the anode electrode, and the pulse mode current output from the pulse generating device 3 is configured to be applied to the metal substrate 4, which is serving as the anode electrode.

The above described pulse generating device 3 has a function of generating an arbitrary pulse mode in the pulse generating device 3 and outputting a current. Any of a positively polarized anode-type pulse mode, a negatively-polarized cathode-type pulse mode, and an alternating pulse mode alternatively exhibiting them, which will be described later, is configured to be supplied from the pulse generating device 3 to the metal substrate 4, which is serving as the anode electrode, so as to execute plasma electrolytic oxidation. The pulse modes output from the pulse generating device 3 will be described later.

On the other hand, on a bottom surface part of the above described electrolytic bath 1, a heat exchanger 5 for cooling the electrolytic solution is disposed so as to extend over approximately the entire surface thereof. A cooling medium supplied from a cooling device 6 is sent to the heat exchanger 5, thereby maintaining the liquid temperature of the electrolytic solution 2 between 10° C. and 40° C. More specifically, when a plasma electrolytic oxide film is started, a high-temperature/high-pressure spot is generated on the surface of the metal substrate 3; therefore, the temperature of the electrolytic solution 2 begins increasing. When the liquid temperature of the electrolytic solution 2 becomes higher than 40° C., for example, SiO2 of the water glass begins separating and eventually solidifies. On the other hand, when the liquid temperature of the electrolytic solution 2 becomes lower than 10° C., various ions, which are generated, for example, in a power distributing process, are coated with an oxygen film, and generation of plasma filaments does not readily occur.

In addition, a filtration device 7 having an arbitrary filter is attached to the above described electrolytic bath 1 via pipes 7a and 7b for circulation so that the electrolytic solution 2 in the electrolytic bath 1 is fed to the filtration device 7 and always maintained to be clean, and all the interior part of the electrolytic bath 1 is approximately uniformly subjected to bubbling by the air fed from an air supplying device 8 to the bottom side of the electrolytic bath 1.

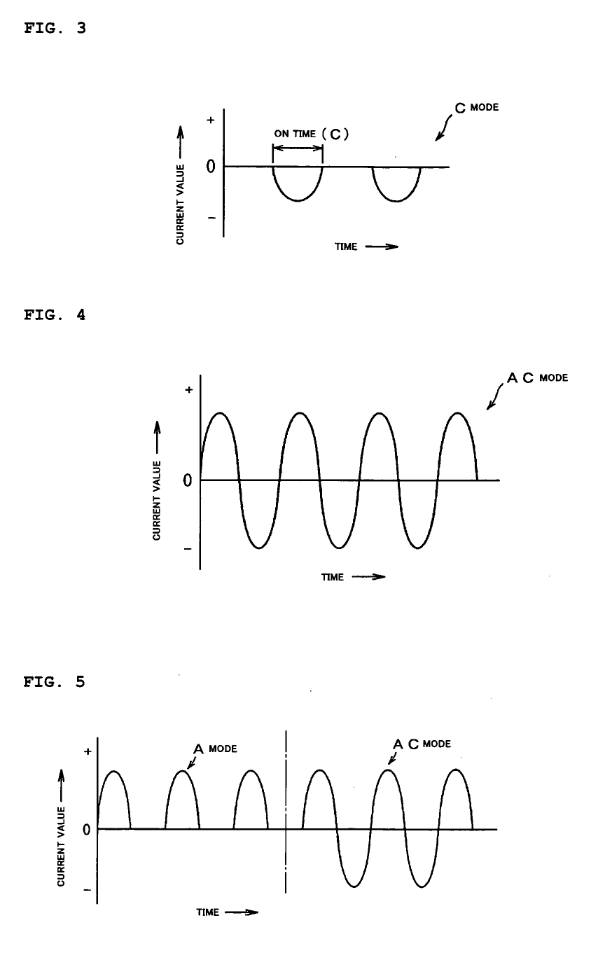

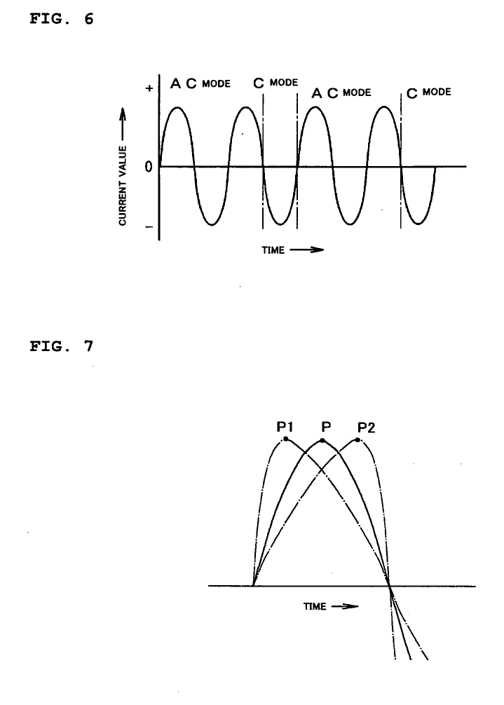

Furthermore, as described above, the pulse generating device 3 has the function of generating an arbitrary pulse mode in the pulse generating device 3 and outputting a current. When the metal substrate 4 is the Al-based metal, first, the current of one or more positively-polarized anode-type pulse mode (hereinafter, referred to as the A mode. See FIG. 2) is applied to the metal substrate 4, which is serving as the anode electrode, as shown in FIG. 5, for example, for 20 minutes. Then, the current of the alternating pulse mode (hereinafter, referred to as the AC mode. See FIG. 4) in which the A mode and the negatively-polarized cathode-type pulse mode (hereinafter, referred to as the C mode. See FIG. 3) alternately appear is applied thereto, for example, for 20 to 60 minutes.

The above described A mode causes a plasma electrolytic oxide film to be formed through power distribution thereof while applying compressing force and, at the same time, has the function of densifying the plasma electrolytic oxide film and smoothing the surface of the formed film. In the A mode, the film formation speed of the plasma electrolytic oxide film, the degree of densification, the smoothness of the surface, etc. can be varied by adjusting, for example, the on time (A) of one anode pulse. For example, when the on time (A) of the A mode is extended, the active state of the high-temperature/high-pressure spot is maintained longer; as a result, the film formation speed of the plasma electrolytic oxide film is increased, the film is densified, the deformation volume of the oxide is also increased, thereby advancing smoothness of the surface.

On the other hand, the C mode comprises a plurality of (two in FIG. 3) cathode pulses, which are negatively polarized, wherein one mode is formed by cyclically disposing pulses. When power is distributed in the C mode, the growth operation of the plasma electrolyte oxide film is stopped; however, a cathode discharge, which generates a high temperature, occurs on the surface of the already-formed plasma electrolytic oxide film, for example, at a protruding portion where an electric field is concentrated. Therefore, at the discharge spot, part of the plasma electrolytic oxide film is melted, and a smoothing action against the surface of the plasma electrolytic oxide film appears in complex with the compressing action by the applied voltage.

More specifically, the C mode has the action of, so to say, peeling off the protruding portion of the surface of the plasma electrolytic oxide film, which is formed in the above described A mode, and promoting smoothing. In the C mode, the smoothness of the surface of the plasma electrolytic oxide film can be adjusted by adjusting the on time (C) of, for example, one cathode pulse. For example, when the on time (C) is extended, the discharge spot is maintained longer; therefore, the protruding portion, etc. of the surface can be reliably melted, and the smoothness of the surface can be enhanced.

The pulse mode of the distributed current output from the pulse generating device 3 is based on the above described A mode and the C mode, and arbitrary combinations thereof are used. Among the combinations, when power is distributed in the AC mode shown in FIG. 4, the actions of the above described A mode and C mode continue alternately acting on the surface of the formed plasma electrolytic oxide film. As a result, a dense, uniform, and smooth plasma electrolytic oxide film is reliably and stably formed.

In the AC mode, the on time of the anode pulses and the on time of the cathode pulses are arbitrarily set. However, in order to reliably form a plasma electrolytic oxide film, it is desired that the total of the on time of the anode pulses be set to be longer than the total of the on time of the cathode pulses so that the amount of the electric power of the anode pulses, which is an integral value of the half-wavelength, is larger than that of the cathode pulses.

In addition, in that case, as shown in FIG. 7, as the current waveform of each pulse mode, a deformed sine waveform in which a peak position P of the current waveform is shifted from the pulse center position in the direction of the time axis like P1 or P2 is used. This is for the reason that the plasma electrolytic oxide film can be efficiently formed since characteristics upon pulse rise or pulse decay become stronger, and stronger plasma reactions can be obtained. P2 which is in the time-delayed direction is used in the case in which surface roughness exhibiting good surface coarseness is more important than high hardness, and P1 in the time-advanced direction is used in the case in which high hardness is more important than the surface roughness exhibiting good surface coarseness. Such deformation of the current waveforms is carried out by arbitrary digital processes in the above described pulse generating device 3.

On the other hand, when the Mg-based metal or the Ti-based metal is used as the above described metal substrate 4, which is serving as the anode electrode, a distribution pattern of a combination of the AC mode (for example, 5 to 45 seconds) and the C mode (for example, 5 to 30 seconds) is preferably used. This is for the reason that, when the AC mode is executed after applying the A mode output to the Mg-based metal or the Ti-based metal, the adhesiveness of the formed coating and the surface of the metal substrate is lowered, and the substrate surface part is readily decolored in the case of the Ti-based metal; therefore, plasticity of the metal substrate is changed when the A mode is applied. Film formation can be carried out by merely applying the AC mode; however, when the C mode is applied, the surface roughness of the metal substrate surface part is stabilized.

According to the manufacturing method of the ceramics coating metal material according to the present embodiment, first, stability and safety is improved compared with a conventional neutral electrolytic solution since the neutral or weak alkaline electrolytic solution 2 is used, and the cathode electrode, which has been conventionally immersed in an electrolytic solution, is constituted by the electrolytic bath 1, thereby forming a uniform electric field and improving the uniformity and quality stability of the plasma electrolytic oxide film (ceramics film).

Furthermore, in the present embodiment, the power distribution pattern combining the anode-type pulse mode (A mode) or the cathode-type pulse mode (C mode) and the alternating pulse mode (AC mode) is employed as applied pulse modes. Particularly by the power distribution pattern of the combination of the AC mode and the C mode, a plasma electrolytic oxide film (ceramics film) can be formed well also on the Mg-based metal and the Ti-based metal.

Furthermore, in the present embodiment, as a result of disposing the heat exchanger 5 for cooling at the bottom portion of the electrolytic bath 1, the electrolytic solution 2 can be cooled from the bottom side, a uniform temperature distribution can be realized, and uniformity of the plasma electrolytic oxide film (ceramics film) can be improved; in addition, as a result of using the metal substrate which has undergone the neutral degreasing step and the water-washing step as the metal substrate 4, the plasma electrolytic oxide film (ceramics film) can be reliably uniformized.

In addition, in the above described embodiment, the deformed sine waveform in which the peak position is shifted is used as the pulse current waveform of the applied pulse mode; as a result, the characteristics upon pulse rise or pulse decay are enhanced, and stronger plasma reactions can be obtained.

Results of testing plasma electrolytic oxide films (ceramics films), which are formed by the above described present embodiment, by a hardness tester (Mitsutoyo HM-124) are shown in tables. In the tables, “OK” represents a measurement result within the range in which notational cross lines can be slightly observed, P1 represents somewhat coarse surface roughness (aim at hardness), P2 represents normal surface roughness (normal mode), and P3 represents smooth surface roughness (aim at smooth feeling).

TABLE 1

| LOAD | MARKING • N | HV | EVALUATION |
|---|---|---|---|
| 3 g | NG | — | x |
| 10 g | NG | — | x |
| 100 g | NG | — | x |
| 500 g | NG | — | x |
| 2 kg | OK • SOMEWHAT | 1801 | ∘ |
| | DISAPPROVING • P1 | | |
| 2 kg | OK • SOMEWHAT | 2206 | ∘ |
| | DISAPPROVING • P1 | | |
| 2 kg | OK • SOMEWHAT | 2304 | ∘ |
| | DISAPPROVING • P1 | | |
| 2 kg | OK • P2 | 1443 | ∘ |
| 2 kg | OK • P2 | 1408 | ∘ |
| 2 kg | OK • P2 | 1497 | ∘ |
| 2 kg | OK • P3 | 1439 | ∘ |
| 2 kg | OK • P3 | 1398 | ∘ |

TABLE 2

| LOAD | MARKING • N | HV | EVALUATION |
|---|---|---|---|
| 2 kg | OK | 1741 | ∘ |
| 2 kg | OK | 1779 | ∘ |
| 2 kg | OK | 2247 | ∘ |
| 500 g | NG | — | x |

TABLE 3

| LOAD | MARKING • N | HV | EVALUATION |
|---|---|---|---|
| 5 g | OK | 77 | ∘ |
| 5 g | OK | 77 | ∘ |

TABLE 4

| LOAD | MARKING • N | HV | EVALUATION |
|---|---|---|---|
| 50 g | NG | — | x |
| 500 g | NG (OVER) | — | x |
| 200 g | OK | 822 | ∘ |
| 200 g | OK | 794 | ∘ |

The invention accomplished by the present inventor has been explained above in detail based on the embodiment; however, the present invention is not limited to the above described embodiment, and it goes without saying that various modifications can be made without departing from the gist thereof.

### INDUSTRIAL APPLICABILITY

The above described present invention can be applied not only to the Al-based metal but also to the Mg-based metal and the Ti-based metal.

### DESCRIPTION OF REFERENCE NUMERALS

ELECTROLYTIC BATH 1
1 ELECTROLYTIC BATH
2 ELECTROLYTIC SOLUTION
3 PULSE GENERATING DEVICE
4 METAL SUBSTRATE (ANODE ELECTRODE)
5 HEAT EXCHANGER
6 COOLING DEVICE
7 FILTRATION DEVICE
7a, 7b PIPES FOR CIRCULATION
8 AIR SUPPLYING DEVICE

1. A manufacturing method of a ceramics coating metal material including
storing a neutral or weak alkaline electrolytic solution of at least stirred and mixed alkali metal hydroxide, alkali metal silicate, and alkali metal polyphosphate in an electrolytic bath;
immersing a metal substrate comprising an Al-based metal, an Mg-based metal, or a Ti-based metal as an anode electrode in the electrolytic solution and constituting the electrolytic bath, which is storing the electrolytic solution, as a cathode electrode;
distributing a current of an arbitrary pulse mode between the metal substrate and the cathode electrode so as to generate a plasma discharge on a contact interface between the metal substrate and the electrolytic solution and subject a surface part of the metal substrate to a conversion process into a plasma electrolytic oxide film;
using merely a power distribution pattern disposing an alternating pulse mode, in which one positively-polarized anode-type pulse mode and one negatively-polarized cathode-type pulse mode alternately appear, as the arbitrary pulse mode;
setting the total of on time of the anode-type pulse mode to be longer than the total of on time of the cathode-type pulse mode so that the amount of electric power of the anode-type pulse mode is larger than the amount of electric power of the cathode-type pulse mode; and
using a deformed sine waveform P2 or P1 as a current waveform of the pulse mode, the deformed sine waveform being time-delayed or time-advanced and having a peak position of the current waveform shifted from a pulse center position in a time axis direction in accordance with surface roughness or hardness of the plasma electrolytic oxide film; wherein
the deformed sine waveform P2 in the time-delayed direction is used when the plasma electrolytic oxide film is to have surface roughness of good surface coarseness than having high hardness; and the deformed sine waveform P1 in the time-advanced direction is used when the plasma electrolytic oxide film is to have high hardness than having surface roughness of good surface coarseness.

2. The manufacturing method of the ceramics coating metal material according to claim 1, wherein a cooling device which causes a cooling medium to flow is disposed on a bottom part of the electrolytic bath.

3. The manufacturing method of the ceramics coating metal material according to claim 1, wherein a metal substrate which has undergone a neutral degreasing step and a water-washing step is used as the metal substrate and is subjected to a drying step after the conversion process.

4. A ceramics coating metal material, wherein a plasma electrolytic oxide film is formed on a surface part of a metal substrate comprising an Al-based metal, a Mg-based metal, or a Ti-based metal by using the manufacturing method of the ceramics coating metal material according to claim 1.
